(19) United States
(12) Patent Application Publication
(10) Pub. No.: US 2015/0379579 A1
(43) Pub. Date: Dec. 31, 2015

(54) SPONSORED DATA SYSTEM AND METHOD

(71) Applicants: Mung Chiang, Princeton, NJ (US); Jagannath Shantigram, Bangalore (IN); Carlee Joe-Wong, Princeton, NJ (US); Harjot Saluja, Nashua, NH (US)

(72) Inventors: Mung Chiang, Princeton, NJ (US); Jagannath Shantigram, Bangalore (IN); Carlee Joe-Wong, Princeton, NJ (US); Harjot Saluja, Nashua, NH (US)

(73) Assignee: TUBE, INC., Chelmsford, MA (US)

(21) Appl. No.: 14/755,983

(22) Filed: Jun. 30, 2015

Related U.S. Application Data
(60) Provisional application No. 62/018,722, filed on Jun. 30, 2014.

(51) Int. Cl. G06Q 30/02

(52) U.S. Cl. CPC G06Q 30/0267

(57) ABSTRACT

A sponsored data system and method are disclosed. The system is configured to operate with a wireless mobile device running an app that receives sponsored data from a content provider server. The system includes an interface application or SDK configured to run on the wireless mobile device, the SDK being configured to determine availability of sponsored data. The system also includes a cloud platform configured to interface with the content provider server, the cloud platform being configured to generate a token with data usable to determine availability of sponsored data and transmit the token to the SDK. The system also includes a portal configured to create and store promotion packages that identifies at least a portion of the data associated with the app as sponsored data.

### CROSS-REFERENCE TO PRIOR FILED APPLICATION

This application claims priority to an earlier filed provisional application 62/018,722 filed on Jun. 30, 2014, which is herein incorporated by reference in its entirety.

### TECHNICAL FIELD

This invention relates generally to systems and methods for data transfers and access payments in a cellular data network and in more particular sponsored data systems configured to allow content providers and third party sponsors to pay for transferring data to user devices.

### BACKGROUND

Most transactions over a wireless data network (e.g., downloading a website or streaming a video) can be viewed as an exchange of data between a client device, such as a smartphone or tablet, and a content server. For instance, a users' smartphone might download a website from a remote server, or might contact a video server to stream a movie. These data transfers occur over a network owned and maintained by an Internet service provider (ISP), which charges for data transactions.

Traditionally, owners of the client devices have paid these data access fees. Most ISPs require end users of client devices to buy a mobile data plan from them, which allows a certain volume of data to be transferred to and from that device over the ISP's network. Recent growth in the volume of mobile data traffic has dramatically increased the cost of maintaining and expanding mobile data networks, driving up the cost for mobile data plans. Users are in turn curtailing their data usage, driving a need for a different system configuration that can unlock the value of mobile broadband data and bring in other forms of paying for the data consumption.

### SUMMARY OF THE INVENTION

This need has resulted in the development of a system configured to allow content providers and third party sponsors (generically called Sponsors in this document) to pay for transferring data to user devices. This allows Sponsors to associate their brand with a particular content that they would like to sponsor, or in case of content providers incentivize users to download their own content, as the cost of downloading the content is paid by the Sponsor instead of the user. The disclosed “sponsored data” system—breaks up the delivery pipe into small chunks equal the unit required to transfer a particular piece of content to the user, as opposed to the whole pipe. It should be understood that the term “sponsored data” as used herein also encompasses split billing, zero rating, toll free data, 1-800 mobile data, two-sided data pricing. The system allows Sponsors to come forth and pay for these small chunks in exchange for brand promotion, or content promotion or user incentives etc. This benefits users, by letting them consume content that they care for for free, benefit Sponsors as they get brand recognition and advertising mileage through the content, and can benefit content providers by increasing user engagement with their content.

Deploying a sponsored data platform in ISP networks presents three significant challenges: 1) Traditionally the data unit is identified only by the user who is consuming it and paid for by a single entity (i.e. the subscriber or perhaps in some cases an employer paying for the subscriber's bill). A Sponsor is only interested to pay for a chunk of data pertaining to the sponsored content and that which fits in the Sponsor's budget for the activity—there is no way today to identify each chunk of data and do so within the requirements of the Sponsor. 2) The ISP's or operator's systems are not designed to scale to identify and count individual chunks of data and bill them separately to Sponsors. Today the operator's systems count the data being exchanged in a connection with the user and are designed to bill a single entity for that pipe. 3) The subscriber needs to know before consuming the data, if someone else is paying for the data transfer. This enables the subscriber to make an informed decision whether to download data or not. Today there is no integrated way for subscriber to know when and if each and every chunk of data is being paid for by a third party—either the content provider or a Sponsor.

ISPs must not only track the total volume of data consumed by each user, as is done currently, but also separate out the volume of sponsored data for each content provider/sponsor in order to bill them. Moreover, content providers or third party Sponsors may wish to sponsor data for only a subset of their users. For instance, Twitter might sponsor Twitter access for baseball game attendees at Fenway Park. To enforce such a sponsored data scenario, the ISP would need to identify the eligible users and then track the amount of data they used on Twitter during the baseball game. Their usage accounting must support time-, app-, location-, and user-based granularity.

In addition to detailed accounting support, a sponsored data platform must also inform users that their data is being sponsored. Thus, the platform integrates with both the ISP, in order to enforce accurate usage counting, and the content provider, in order to inform users that their data is being sponsored.

The disclosed sponsored data system enables a marketplace where content is available to be sponsored and anyone would have the ability to sponsor the broadband data required for transferring the data to the user devices for consumption of content.

The disclosed sponsored data system and method can be summarized as following: a dynamic platform for sponsored data that a) identifies each and every chunk of content that a Sponsor would like to pay for the data transfer (sponsored data), b) integrates with the ISP to enable the ISP to not charge the subscriber for the sponsored data, c) enables the reverse billing for each content so it can be charged separately to the Sponsor.

The disclosed system may be implemented using an interface application that interfaces between sponsored data management software and mobile applications on user devices or a web-based interface application to integrate with Content Sites, to package each chunk of sponsored data and to inform users of dynamically available data sponsorships. It should be understood that the interface application may be implemented as an SDK. The interface application or SDK integrates with a provisioning and accounting platform in the cloud that; a) integrates with the ISP network for detailed sponsored data accounting; b) provides an analytics portal for content providers and ISPs to view statistics of the types and users of sponsored data; and c) allows Sponsors to create promotion packages by specifying the users, content to sponsor, and monetary amount to sponsor in a way that is possibly location-, time-, content-, and user-specific. The SDK includes a dynamic approval engine that decides if a chunk of data corresponding to any content is sponsored by a third party or to be paid for by subscriber. It also includes a cache DB on the device to cache the rules associated with the sponsorship for efficiency and it includes a messaging infrastructure to appropriately message the user prior to the data flow so the user can decide to consume content or not.

The sponsored data platform generally includes three main components: an SDK on user devices, a cloud component interfacing with ISP networks and content provider servers, and a portal for creating promotion packages and viewing sponsored data analytics.

The SDK is integrated into the apps that content providers wish to sponsor or into the content web site. It handles control plane communication with the cloud component, verifying user eligibility for different promotion packages, and ensuring that such sponsored traffic is flagged appropriately to distinguish it from non-sponsored data. The SDK also providers information such as the user ID and location, enabling detailed accounting in the cloud component. Handling this communication through a pre-built SDK makes the system modular, simplifying the content provider's integration with the ISP.

The SDK can also be used to gather network quality information and send it to the cloud. For instance, data traffic during times of lower congestion generally costs ISPs less than traffic at congested times. Thus, if the ISP wishes to give discounts to data sponsored at less congested times, the SDK can be used to determine network congestion in real-time for each user.

The cloud component interfaces with the SDK, the ISP network, and the content providers' servers. The cloud component has several DNS server and proxy boxes located in datacenters throughout the world, easily allowing devices to access the nearest box when using sponsored data. Data traffic flagged by the SDK as sponsored passes through the ISP network and proxy box, where it is counted and associated with a timestamp, user ID, and app.

The data counts are stored in a database in the cloud, which connects to an analytics server and external portal. The portal can be accessed by ISPs, content providers and third party Sponsors with different access privileges. ISPs can view the sponsored data usage volumes for different apps on its network at different times and locations. The analytics server compares this usage to historical usage patterns and highlights found anomalies. Content providers can similarly view sponsored data usage for different users and locations, as well as, the amount of data used with different promotion packages.

A separate screen of the portal allows sponsors to create and purchase sponsored data promotion packages. Each content provider views a sponsored data marketplace listing the apps available to be sponsored (i.e., those integrated with the SDK). Content providers with integrated apps can also provide specific URL links to be sponsored; the SDK can then flag traffic as sponsored only for those URLs.

To create a promotion package, the content provider first specifies the content (apps and URL links) to be sponsored by the package. The provider then specifies the users eligible for this package. ISP network, specific phone numbers, user location or other demographic information imported from a database may be used to specify users. Finally, the content provider specifies the monetary amount it is willing to spend on this promotion package as well as package expiration dates. Further details such as location, time, content, and user type specificity can be prescribed too.

In more detail, a sponsored data system is disclosed. The system is configured to operate with a wireless mobile device running an app that receives sponsored data from a content provider server. The system includes an interface application configured to run on the wireless mobile device, the interface application being configured to determine availability of sponsored data. The system also includes a cloud platform configured to interface with the content provider server, the cloud platform being configured to generate a token with data usable to determine availability of sponsored data and transmit the token to the interface application. The system also includes a portal configured to create and store a promotion package that identifies at least a portion of the data associated with the app as sponsored data.

The cloud platform may be configured to transmit caching rules to the interface application, the caching rules including at least one of an amount of data that is sponsored, a duration, a type of content associated with the token, the interface application being configured to determine availability of sponsored data based on the token and the caching rules. The system may also include a proxy box configured to receive sponsored data from the content provider server and send the sponsored data to the wireless mobile device, the proxy box being configured to record a number of bytes of sponsored data sent to the wireless mobile device. The system may also include an analytics server configured to receive the number of bytes of sponsored data from the proxy box and aggregate usage information for each sponsored data session.

The portal may be configured to allow a content provider to select content associated to be sponsored in a promotion package. The portal may be configured to store a plurality of parameters associated with the promotion package, the parameters including at least one of an amount of money left in the promotion package, an identification of the content sponsored by the promotion, users eligible for the promotion, a mobile data operator and a location of user device. The portal may be configured to store a list wireless mobile device phone numbers that are eligible to receive sponsored data. The portal may be configured to store a list of ISP networks associated with sponsored data. The portal may be configured to store at least one of an amount of money allocated towards providing sponsored data in a given promotion package, a maximum spending per user and per app included in the promotion package, and an expiration date and time.

A sponsored data distribution method is also disclosed. The method is also configured to operate with a wireless mobile device running an app that receives sponsored data from a content provider server. The method includes providing an interface application configured to run on the wireless mobile device, the interface application being configured to determine availability of sponsored data. A cloud platform is also provided and is configured to interface with the content provider server, the cloud platform being configured to generate a token with data usable to determine availability of sponsored data and transmit the token to the interface application. A portal is also provided and is configured to create and store a promotion package that identifies at least a portion of the data associated with the app as sponsored data.

The cloud platform may be configured to transmit caching rules to the interface application, the caching rules including at least one of an amount of data that is sponsored, a duration, a type of content associated with the token, the interface application being configured to determine availability of sponsored data based on the token and the caching rules. The system may also include a proxy box configured to receive sponsored data from the content provider server and send the sponsored data to the wireless mobile device, the proxy box being configured to record a number of bytes of sponsored data sent to the wireless mobile device. The system may also include an analytics server configured to receive the number of bytes of sponsored data from the proxy box and aggregate usage information for each sponsored data session.

The portal may be configured to allow a content provider to select content associated to be sponsored in the promotion package. The portal may be configured to store a plurality of parameters associated with the promotion package, the parameters including at least one of an amount of money left in the promotion package, an identification of the content sponsored by the promotion package, users eligible for the promotion, a mobile data operator and a location of user device. The portal may be configured to store a list wireless mobile device phone numbers that are eligible to receive sponsored data. The portal may be configured to store a list of ISP networks associated with sponsored data. The portal may be configured to store at least one of an amount of money allocated towards providing sponsored data in the promotion package, a maximum spending per user and per app included in the promotion package, and an expiration date and time.

### BRIEF DESCRIPTION OF THE FIGURES

FIG. 1 shows a sponsored data container on the user device. Data traffic for all apps displayed in the container is sponsored. The apps displayed change dynamically as promotions expire and the user moves in and out of locations where data is sponsored.

FIG. 2 shows the overall architecture of the system. Different user devices can access sponsored data by first communicating with the DNS cloud component of the system. User data then travels through the proxy box to the content provider server and obtain the sponsored content. Devices connect to the physically nearest box to reduce network latency. Accounting information is stored in a separate database and analytics server, which directly connects to the external portal.

FIG. 3 shows a content provider's portal home screen. The provider sees a list of its promotion packages to the left and can select each to view its details. These include the amount of money left in the promotion, the content sponsored by the promotions, and users eligible for the promotion.

FIG. 4 shows a portal screen allowing a content provider to select content to be sponsored in a promotion package. The provider can search through available apps or add URL links.

FIG. 5 shows a portal screen allowing a content provider to select users eligible for a promotion package. The provider first specifies the ISP networks on which it wishes to sponsor data (e.g., sponsoring Twitter for all AT&T subscribers at a baseball game). It can also upload a list of specific device phone numbers or select an area of eligible user locations on a map.

FIG. 6 shows a portal screen allowing a content provider to specify the amount of money it is willing to spend on the package. The provider can also specify maximum spending per user and per app included in the package. Finally, the provider can specify expiration dates and times, e.g., the start and end of a baseball game.

FIG. 7 is a block diagram showing operation of the interface application or SDK in determining and marking a sponsored data content.

### DETAILED DESCRIPTION

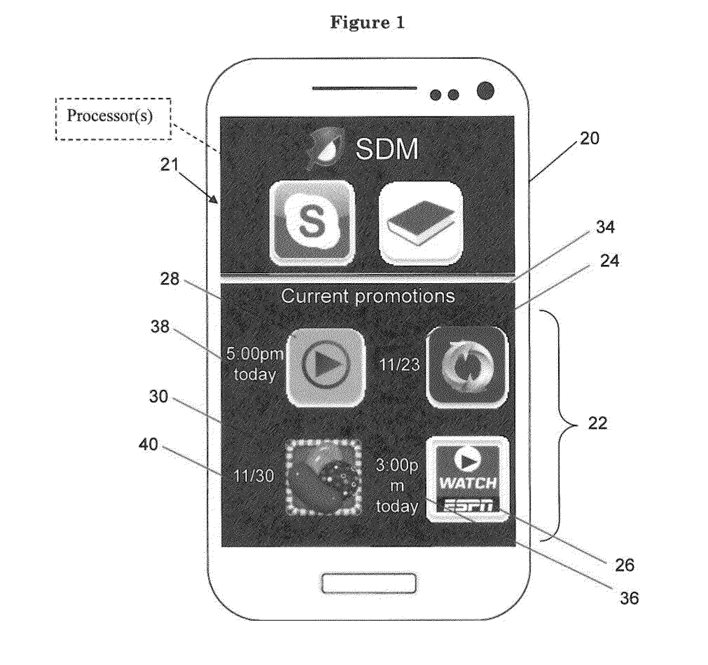

FIG. 1 is a block diagram showing a sponsored data container 21 on a user device 20. The sponsored data container 21 includes a display area 22 for sponsored promotions displaying data associated with one or more sponsored app (app have sponsored data). Data traffic for all apps displayed in the container is sponsored. The apps 24, 26, 28, 30 displayed change dynamically, e.g., showing an expiration date/time 34, 36, 38, 40, as promotions expire and the user moves in and out of locations where data is sponsored.

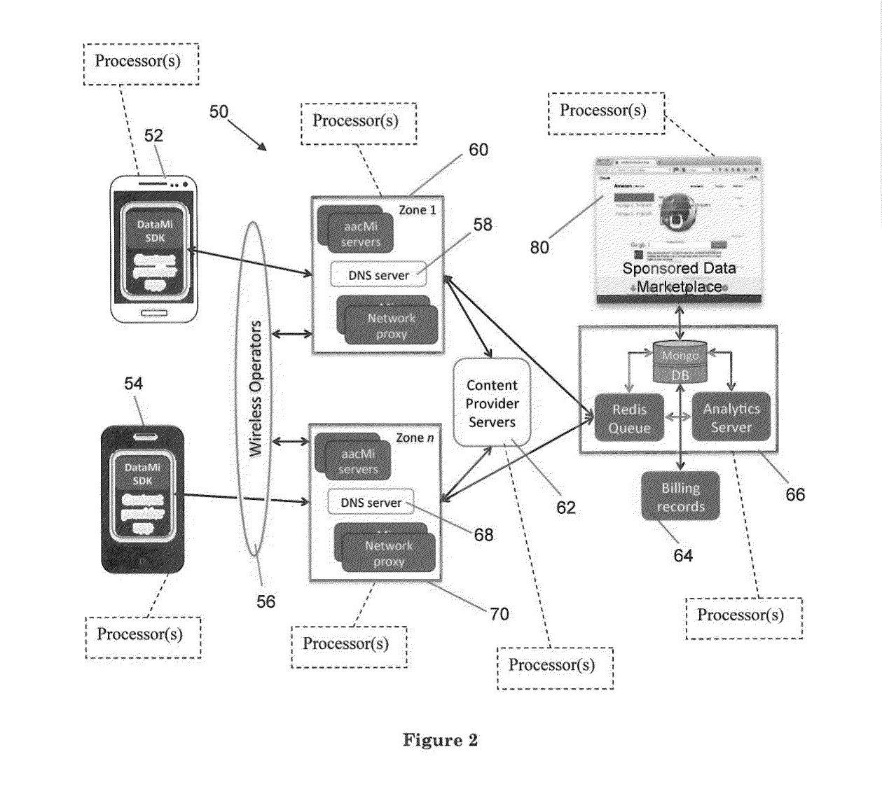

FIG. 2 shows the overall system architecture of the sponsored data system 50. Different user devices 52, 54 can access sponsored data via wireless operator 56 by first communicating with the DNS cloud component 58, 68 of the sponsored data system. User data then travels through the proxy box 60, 70 to the content provider server 62 and obtain the sponsored content. User devices 52, 24 connect to the physically nearest proxy box 60, 70 to reduce network latency. Accounting information is stored in a separate billing database 64 and analytics server 66, which directly connects to the portal 80.

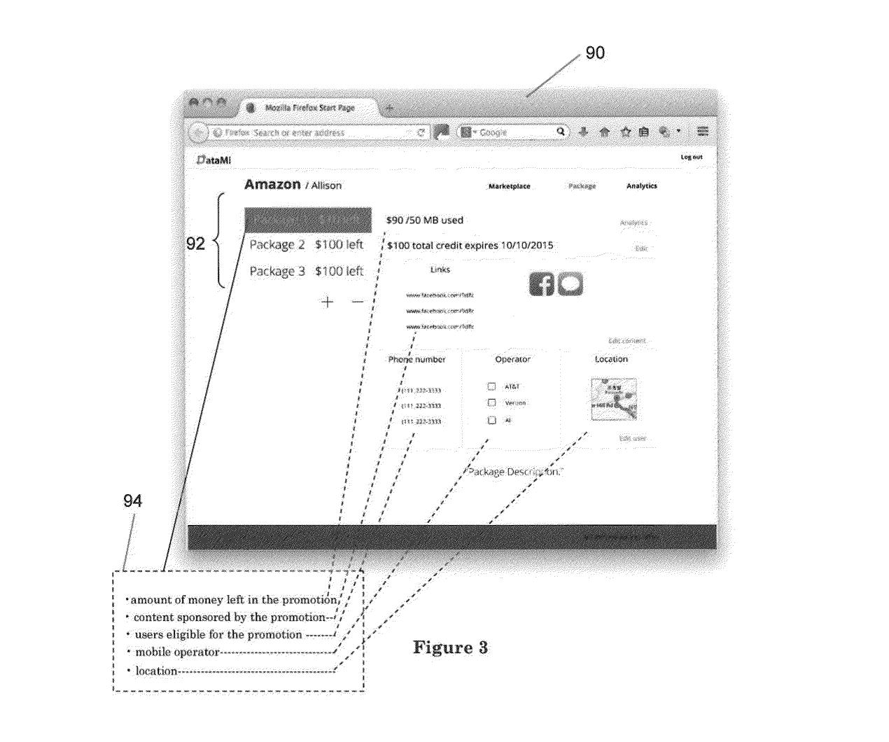

FIG. 3 shows a content provider's portal home screen. The provider sees a list of its promotion packages 92 to the left and can select each to view its associated parameters 94 stored by the portal. These promotion parameters 94 include the amount of money left in the promotion, the content sponsored by the promotions, users eligible for the promotion, mobile data operator and the location of user device.

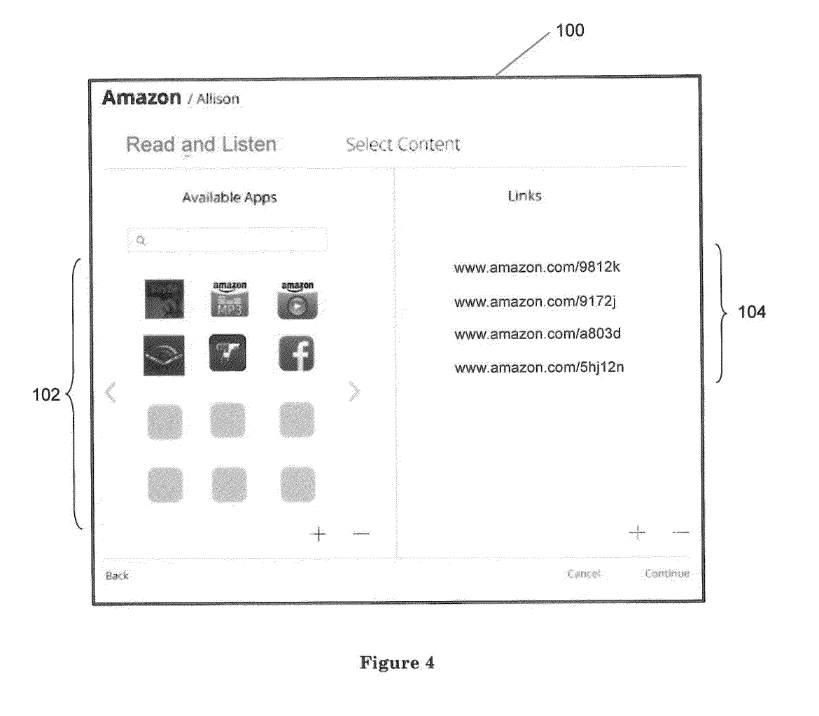

FIG. 4 shows a portal screen 100 configured to allow a content provider to select content associated to be sponsored in a promotion package. The provider can search through available apps 102 or add URL links 104.

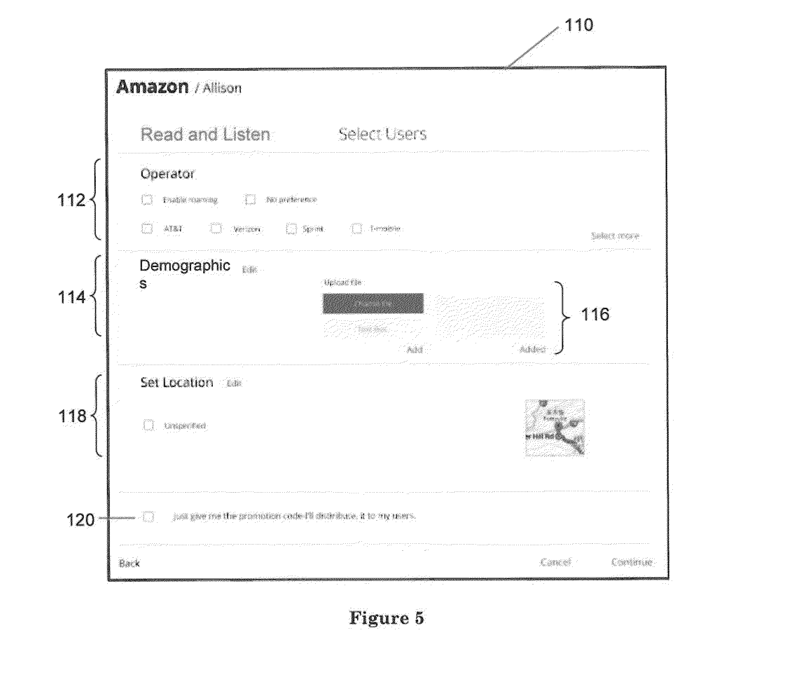

FIG. 5 shows a portal screen 110 configured to allow a content provider to select users eligible for a promotion package. The provider first specifies the ISP networks 112 on which it wishes to sponsor data (e.g., sponsoring Twitter for all AT&T subscribers at a baseball game). It can also upload a list of specific device phone numbers as shown generally by reference number 116 or select an area of eligible user locations on a map 118. The portal can also generate a set of promotion codes for distribution to users as shown generally by reference number 120.

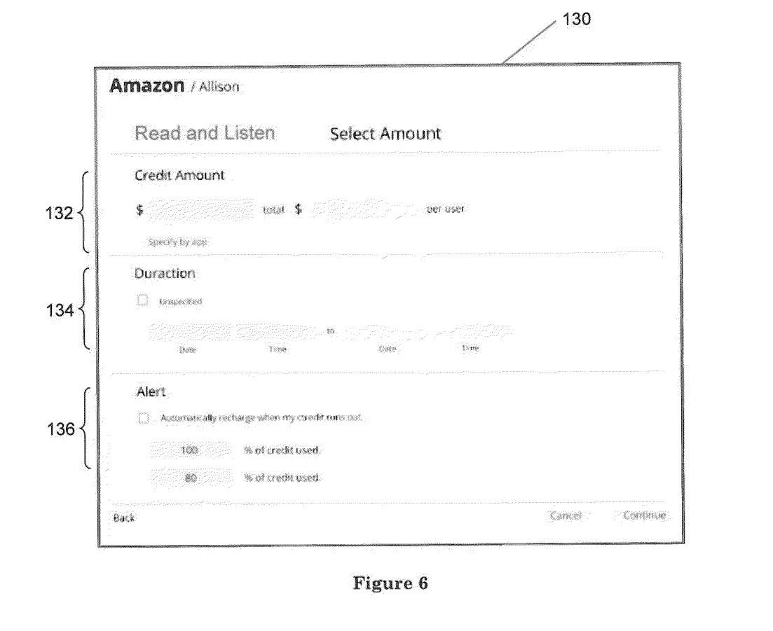

FIG. 6 shows a portal screen 130 configured to allow a content provider to specify the amount of money it is willing to spend on the package as shown generally by reference number 132. The provider can also specify maximum spending per user and per app included in the package. The provider can also specify expiration dates and times, e.g., the start and end of a baseball game as shown generally by reference number 134. The portal can also generate alerts to notify the content provider as credit is running out game as shown generally by reference number 136.

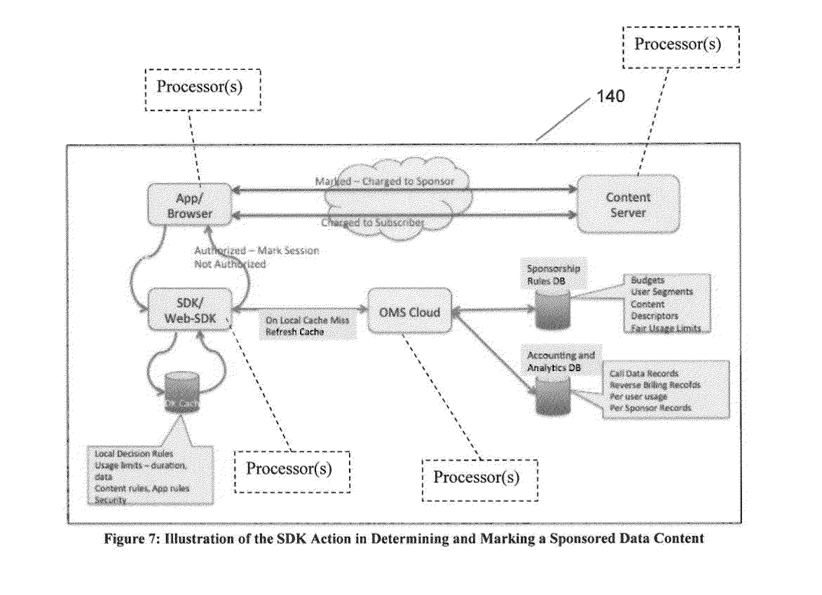

FIG. 7 is a block diagram 140 showing operation of the interface application or SDK in determining and marking a sponsored data content. FIG. 7 generally illustrates how the SDK acts as the gatekeeper for sponsored data—identifies which content to be sponsored, interacts with the App and the user and enables the sponsored data marketplace. In general the SDK is implemented on the user device. The SDK integrates with a provisioning and accounting platform in the cloud that; a) integrates with the ISP network for detailed sponsored data accounting; b) provides an analytics portal for content providers and ISPs to view statistics of the types and users of sponsored data; and c) allows Sponsors to create promotion packages by specifying the users, content to sponsor, and monetary amount to sponsor in a way that is possibly location-, time-, content-, and user-specific.

When a user opens an app integrated with the SDK on his or her device, the SDK registers the device with the provisioning and accounting in the cloud (cloud platform). The cloud platform returns a list of all sponsored content within the app, which is displayed accordingly to the user. If a user selects a piece of sponsored content, the SDK authorizes the content sponsorship by contacting the cloud platform. The cloud platform generates a token and transmits the token to the SDK. The token, which is also cached on the cloud, is then used by the SDK to validate requests for this piece of content. The operation of the sponsored data may not necessarily need the app to be active or open to start with. Along with the token the cloud platform transmits caching rules to the SDK—such as amount of data that is sponsored, duration, types of content etc., for the token which allows the SDK to make local decisions based on all the app content.

After receiving the token, the SDK appends the token to the sponsored content's URL and sends it to the app. The app uses this URL to request the piece of sponsored data. This request is validated using the token and rerouted to a proxy box in the cloud through DNS lookup of the URL with appended token. The content request is then forwarded through the proxy box to the content provider's server. The server returns the content through the proxy box, which records its size and forwards the content to the app.

The sizes of different pieces of sponsored content are forwarded by the proxy boxes to a separate analytics server in the cloud. This server aggregates information for each sponsored data session to calculate total sponsored data usage for each app, each user, each package, and each content provider. The external portal screen displays this information, which is also parsed to bill content providers according to the amount of data they sponsor.

The portal screens shown in FIGS. 4-6 allow content providers to purchase promotion packages as discussed above. The portal is connected to a backend database configured to store information about all packages. When a user device registers with the cloud, its information is checked against eligible user groups for all promotion packages. Apps in packages for which the user is eligible are then displayed in the sponsored data container on the device. The device initiates device registration, not the cloud, conserving device resources when the user does not wish to access sponsored data.

Some content providers may attempt to sponsor the same apps for the same users at the same time. In case of such conflicts, the cost of sponsorship is split among the content providers, possibly evenly or possibly in proportions determined by other mechanisms such as bidding or auctions. The method for splitting the cost also dictates the promotion of the sponsors' brand associated with that content.

It should be understood that many variations are possible based on the disclosure herein. Although features and elements are described above in particular combinations, each feature or element can be used alone without the other features and elements or in various combinations with or without other features and elements. The methods or flow charts provided herein may be implemented in a computer program, software, or firmware incorporated in a computer-readable (non-transitory) storage medium for execution by a general-purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

It should be understood that the disclosed system as well as other elements that interact with the system, e.g., client devices, wireless mobile devices, cloud platforms, portals, proxy boxes, servers, controllers and the various other devices that implement the system and the radio access/core network may be implemented with one or more processors. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application-Specific Integrated Circuits (ASICs), Field-Programmable Gate Arrays (FPGAs) circuits, any other type of integrated circuit (IC), and/or a state machine.

What is claimed is:

1. A sponsored data system configured to operate with a wireless mobile device running an app that receives sponsored data from a content provider server, the system comprising:
an interface application configured to run on the wireless mobile device, the interface application being configured to determine availability of sponsored data;
a cloud platform configured to interface with the content provider server, the cloud platform being configured to generate a token with data usable to determine availability of sponsored data and transmit the token to the interface application; and
a portal configured to create and store a promotion package that identifies at least a portion of the data associated with the app as sponsored data.

2. The system of claim 1 wherein the cloud platform is configured to transmit caching rules to the interface application, the caching rules including at least one of an amount of data that is sponsored, a duration, a type of content associated with the token, the interface application being configured to determine availability of sponsored data based on the token and the caching rules.

3. The system of claim 1 further comprising a proxy box configured to receive sponsored data from the content provider server and send the sponsored data to the wireless mobile device, the proxy box being configured to record a number of bytes of sponsored data sent to the wireless mobile device.

4. The system of claim 3 further comprising an analytics server configured to receive the number of bytes of sponsored data from the proxy box and aggregate usage information for each sponsored data session.

5. The system of claim 1 wherein the portal is configured to allow a content provider to select content associated to be sponsored in the promotion package.

6. The system of claim 1 wherein the portal is configured to store a plurality of parameters associated with the promotion package, the parameters including at least one of an amount of money left in the promotion package, an identification of the content sponsored by the promotion package, users eligible for the promotion package, a mobile data operator and a location of user device.

7. The system of claim 1 wherein the portal is configured to store a list wireless mobile device phone numbers that are eligible to receive sponsored data.

8. The system of claim 1 wherein the portal is configured to store a list of ISP networks associated with sponsored data.

9. The system of claim 1 wherein the portal is configured to store at least one of an amount of money allocated towards providing sponsored data in the promotion package, a maximum spending per user and per app included in the promotion, and an expiration date and time.

10. The system of claim 1 wherein the interface application is an SDK.

11. A sponsored data distribution method configured to operate with a wireless mobile device running an app that receives sponsored data from a content provider server, the method comprising:
providing an interface application configured to run on the wireless mobile device, the interface application being configured to determine availability of sponsored data;
providing a cloud platform configured to interface with the content provider server, the cloud platform being configured to generate a token with data usable to determine availability of sponsored data and transmit the token to the interface application; and
providing a portal configured to create and store a promotion package that identifies at least a portion of the data associated with the app as sponsored data.

12. The method of claim 11 wherein the cloud platform is configured to transmit caching rules to the interface application, the caching rules including at least one of an amount of data that is sponsored, a duration, a type of content associated with the token, the interface application being configured to determine availability of sponsored data based on the token and the caching rules.

13. The method of claim 11 further comprising providing a proxy box configured to receive sponsored data from the content provider server and send the sponsored data to the wireless mobile device, the proxy box being configured to record a number of bytes of sponsored data sent to the wireless mobile device.

14. The method of claim 13 further comprising providing an analytics server configured to receive the number of bytes of sponsored data from the proxy box and aggregate usage information for each sponsored data session.

15. The method of claim 11 wherein the portal is configured to allow a content provider to select content associated to be sponsored in the promotion package.

16. The method of claim 11 wherein the portal is configured to store a plurality of parameters associated with the promotion package, the parameters including at least one of an amount of money left in the promotion package, an identification of the content sponsored by the promotion package, users eligible for the promotion package, a mobile data operator and a location of user device.

17. The method of claim 11 wherein the portal is configured to store a list wireless mobile device phone numbers that are eligible to receive sponsored data.

18. The method of claim 11 wherein the portal is configured to store a list of ISP networks associated with sponsored data.

19. The method of claim 11 wherein the portal is configured to store at least one of an amount of money allocated towards providing sponsored data in the promotion package, a maximum spending per user and per app included in the promotion package, and an expiration date and time.

20. The method of claim 11 wherein the interface application is an SDK.
